(19) United States
(12) Patent Application Publication
(10) Pub. No.: US 2020/0082017 A1
(43) Pub. Date: Mar. 12, 2020

(54) PROGRAMMATIC REPRESENTATIONS OF NATURAL LANGUAGE PATTERNS

(71) Applicant: Microsoft Technology Licensing, LLC, Redmond, WA (US)

(72) Inventors: Daniel Isaiah Vann, Duvall, WA (US); Donald Frank Brinkman, JR., Seattle, WA (US); Kenneth Max Brooks, Lacey, WA (US); Johnathan Gilbert Cocks, Bellevue, WA (US); Jessica Eleanor Eggerth, Redmond, WA (US); Alex Entrikin, Redmond, WA (US); Chelsea A. Fesik, Seattle, WA (US); Hannah Victoria Trepte, Seattle, WA (US); Spencer Alan Wilkerson, Seattle, WA (US)

(21) Appl. No.: 16/128,678

(22) Filed: Sep. 12, 2018

(51) Int. Cl. G06F 17/30; G06F 17/27

(52) U.S. Cl. CPC G06F 17/30684; G06F 17/274; G06F 17/30696

(57) ABSTRACT

Systems and methods for programmatic representation of natural language patterns are disclosed. A method includes accessing, via an electronic transmission, a text in a natural language. The method includes identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language. The method includes providing an output representing the identified one or more word groups and the at least one stored natural language pattern corresponding to each of the identified one or more word groups.

### BACKGROUND

Identifying natural language patterns in text may be useful, for example, in spelling and grammar checks in word processing software, or in identifying inappropriate content (e.g., sexual content or content that may be offensive to certain groups of people) in communication with a chat bot or within a social networking service.

### BRIEF DESCRIPTION OF THE DRAWINGS

Some embodiments of the technology are illustrated, by way of example and not limitation, in the figures of the accompanying drawings.

FIG. 1 illustrates an example system in which programmatic representation of natural language patterns may be implemented, in accordance with some embodiments.

FIG. 2 illustrates a flow chart for an example method for identifying word group(s) corresponding to natural language pattern(s) in text, in accordance with some embodiments.

FIG. 3 illustrates some example first person natural language patterns, in accordance with some embodiments.

FIG. 4 illustrates some example pronoun natural language patterns, in accordance with some embodiments.

FIG. 5 illustrates an additional example pronoun natural language pattern, in accordance with some embodiments.

FIG. 6 illustrates an example noun natural language pattern, in accordance with some embodiments.

FIG. 7 illustrates an example adjective list pattern, in accordance with some embodiments.

FIG. 8 illustrates an example “be” pattern, in accordance with some embodiments.

FIG. 9 illustrates an example single verb conjugation pattern, in accordance with some embodiments.

FIG. 10 illustrates an example multiple verb conjugation pattern, in accordance with some embodiments.

FIG. 11 illustrates an example single part pattern, in accordance with some embodiments.

FIG. 12 illustrates an example sequential match pattern, in accordance with some embodiments.

FIG. 13 illustrates an example phrase natural language pattern, in accordance with some embodiments.

FIG. 14 illustrates an example broad match natural language pattern, in accordance with some embodiments.

FIG. 15 illustrates an example personal identity natural language pattern, in accordance with some embodiments.

FIG. 16 is a block diagram illustrating components of a machine able to read instructions from a machine-readable medium and perform any of the methodologies discussed herein, in accordance with some embodiments.

### SUMMARY

The present disclosure generally relates to machines configured to provide neural networks, including computerized variants of such special-purpose machines and improvements to such variants, and to the technologies by which such special-purpose machines become improved compared to other special-purpose machines that provide technology for neural networks. In particular, the present disclosure addresses systems and methods for visual recognition via neural network.

According to some aspects of the technology described herein, a method includes accessing, via an electronic transmission, a text in a natural language. The method includes identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language. The method includes providing an output representing the identified one or more word groups and the at least one stored natural language pattern corresponding to each of the identified one or more word groups.

According to some aspects of the technology described herein, a machine-readable medium stores instructions which, when executed by one or more machines, cause the one or more machines to perform operations. The operations include accessing, via an electronic transmission, a text in a natural language. The operations include identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language. The operations include providing an output representing the identified one or more word groups and the at least one stored natural language pattern corresponding to each of the identified one or more word groups.

According to some aspects of the technology described herein, a system includes processing hardware and memory. The memory stores instructions which, when executed by the processing hardware, cause the processing hardware to perform operations. The operations include accessing, via an electronic transmission, a text in a natural language. The operations include identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language. The operations include providing an output representing the identified one or more word groups and the at least one stored natural language pattern corresponding to each of the identified one or more word groups.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

As set forth above, identifying natural language patterns in text may be useful, for example, in spelling and grammar checks in word processing software, or in identifying inappropriate content (e.g., sexual content or content that may be offensive to certain groups of people) in communication with a chat bot or within a social networking service. Generating programmatic representation(s) of natural language pattern(s), and applying such natural language pattern(s) to identify text matching those patterns, may be desirable. As used herein, the phrase “natural language” includes, among other things, any spoken or written language used by humans for communication. Examples of natural languages include English, French, Spanish, Russian, Japanese, Arabic, Latin, and the like.

Some implementations of the technology described herein are direct to solving the technical problem of automatically identifying and interpreting patterns within text. This is done, for example, using generated programmatic representation(s) of natural language pattern(s). In some implementations, a computer (e.g., a server in a network system or a standalone machine) accesses a text in a natural language. The computer identifies, based on a plurality of stored natural language patterns residing in a data repository, one or more word groups within the text. Each word group corresponds to at least one stored natural language pattern. Each stored natural language pattern corresponds to a grammatical part of speech or a word-phrase type in the natural language. The computer provides an output representing the identified one or more word groups and the stored natural language pattern(s) corresponding to each of the identified one or more word groups.

Other schemes solve the technical problem of automatically identifying and interpreting patterns within text using string manipulation. While string manipulation programs are easy for a programmer to code, they are difficult to fine tune and, oftentimes, cannot handle the complexity of natural language.

Yet other schemes solve the technical problem of automatically identifying and interpreting patterns within text using complex regular expression(s). However, complex regular expressions suffer from some drawbacks, such as difficulties in authoring, difficulty in being programmed for and handling patterns (e.g., “Alan, Betsy, Carlos, and Diana go to the shopping center by bus,” has the same structure as, “Alan goes to the shopping center by train and bus”). Also, complex regular expressions require many different changes for different phrase structures and phrase types.

Some aspects of the technology described herein provide simplified abstractions of different aspects of grammar in a natural language, such as English. The simplified abstractions can be used to specify complex patterns so as to represent the complexities of grammar in the natural language. The technology described herein may have strategic value in artificial intelligence-based content generation.

### DESCRIPTION OF FIGURES

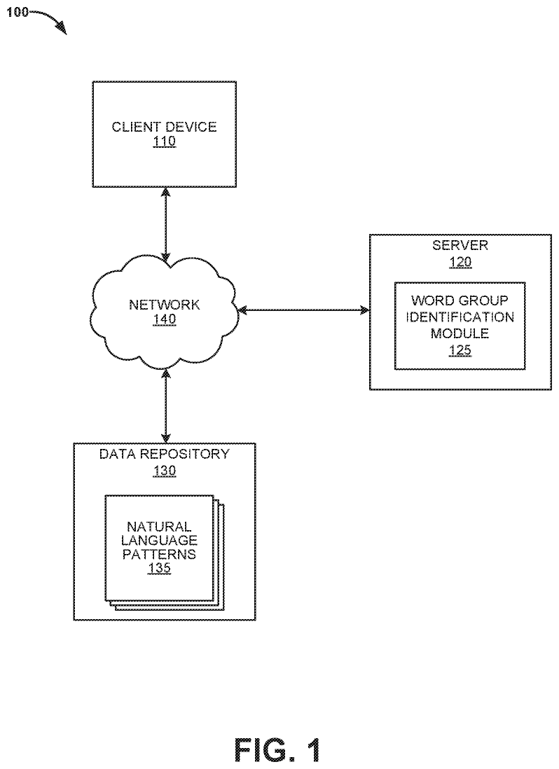

FIG. 1 illustrates an example system 100 in which programmatic representation of natural language patterns may be implemented, in accordance with some embodiments. As shown, the system 100 includes a client device 110, a server 120, and a data repository 130 communicating with one another over a network 140. The network 140 may include one or more of the internet, an intranet, a local area network, a wide area network, a wired network, a wireless network, and the like.

The system 100 is shown to include a single client device 110, a single server 120, and a single data repository 130. However the technology described herein may be implemented with multiple client devices, servers, and/or data repositories. Furthermore, the technology is described in FIG. 1 as being implemented in a system 100 that includes the network 140. However, in alternative embodiments, the technology may be implemented using a single machine (which may or may not be connected to a network) or using multiple machines that are connected to each other via a wired or wireless connection that is not a network.

In some examples, the functions of the server 120 may be performed by multiple different machines. In some examples, the data repository 130 may include multiple different machines. In some examples, a single machine performs the functions of both the server 120 and the data repository 130.

The client device 110 may be a laptop computer, a desktop computer, a mobile phone, a tablet computer, a smart watch, a smart speaker device, a smart television, a personal digital assistant (PDA), and the like. The client device 110 may include any device that is used, by an end user, to provide input or receive output.

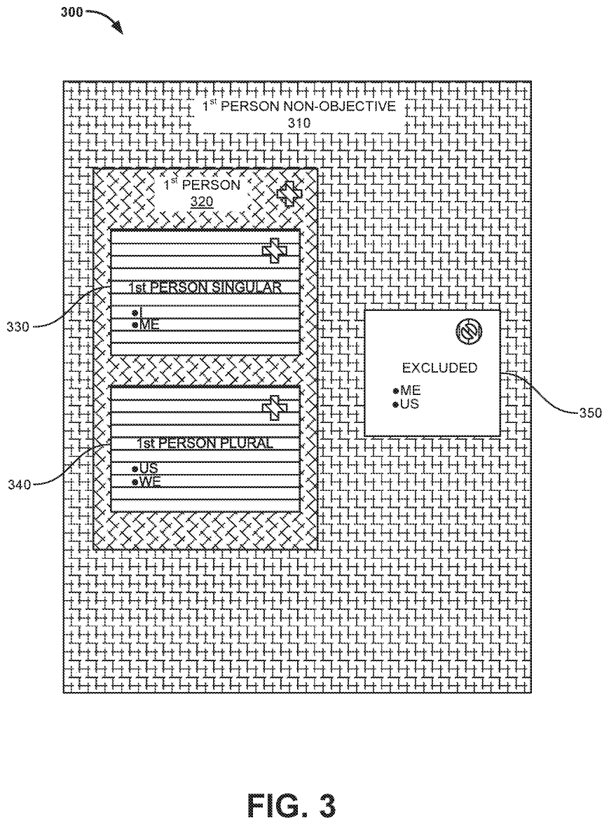

The data repository 130 stores a plurality of natural language patterns 135. Each natural language pattern 135 may be represented as a plaintext file (or using another representation). Each natural language pattern 135 may identify word(s) that match or do not match the pattern or an order of the word(s). Examples of natural language pattern(s) 135 are described in conjunction with FIGS. 3-15. For example, a simple natural language pattern may require that a text include a noun from the set {“mouse”, “cat”, “dog”} and a verb from the set {“walk”, “walks”, “walking”, “walked”}. The sentence “The mouse walks to the house,” matches the pattern because it includes the word “mouse” and “walks.” However, the sentence “Alan goes to the shopping center,” does not match the pattern. Appendix A includes example JSON (JavaScript Object Notation) code for some example natural language patterns, which can be used in conjunction with some implementations of the technology described herein. The natural language patterns in Appendix A may correspond to the natural language patterns 135 stored in the data repository 130. However, other or different natural language patterns may be used in addition to or in place of those in Appendix A. Also, while the patterns in Appendix A are coded in JSON, other scripting or programming languages may be used in addition to or in place of JSON.

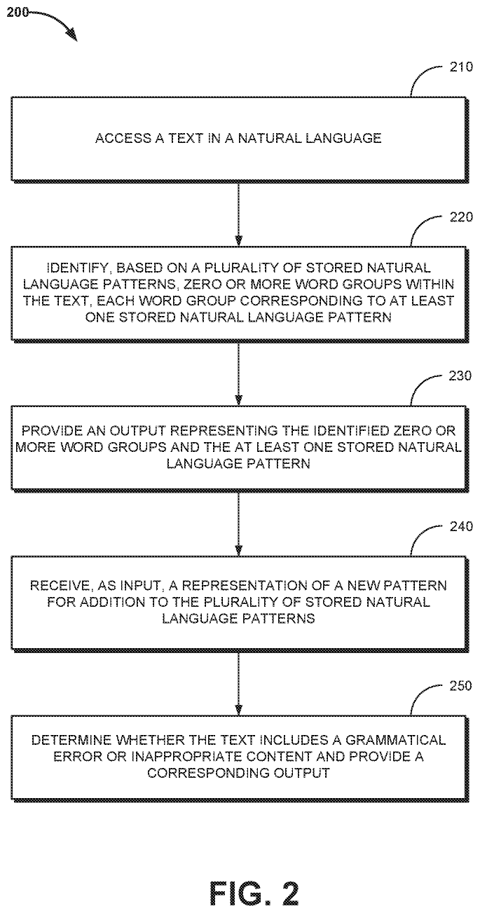

The server 120 stores a word group identification module 125. The word group identification module 125, when executed by the server 120, causes the server 120 to implement all or a portion of the operations of the method 200 described in conjunction with FIG. 2.

FIG. 2 illustrates a flow chart for an example method 200 for identifying word group(s) corresponding to natural language pattern(s) in text, in accordance with some embodiments. The method 200 may be implemented at the server 120 while executing the word group identification module 125.

At operation 210, the server 120 accesses a text in a natural language. The natural language may be a spoken or written language (e.g., English) that is used by humans for communication. The text may be accessed via an electronic transmission from another machine connected to the network 140, such as the client device 110 or another server (e.g., a server associated with a chat bot or a professional networking service).

At operation 220, the server 120 identifies, based on the plurality of stored natural language patterns 135 residing in the data repository 130, zero or more (e.g., one or more or none) word groups within the text. Each word group corresponds to at least one stored natural language pattern 135. Each stored natural language pattern 135 corresponds to a grammatical part of speech or a word-phrase type in the natural language. The word-phrase type may include one or more words or numerical text types. The word group(s) within the text may be identified, for example and without limitation, using one or more of a database query, a compare operation, a search engine, a pattern matching algorithm, or any other mechanism. Some examples of identifying word group(s) within text are discussed below in conjunction with FIGS. 3-15.

At operation 230, the server provides an output representing the identified zero or more (e.g., one or more or none) word groups and the at least one stored natural language pattern 135 corresponding to each of the identified zero or more word groups.

At operation 240, the server 120 receives (e.g., from the client device 110), as input, a representation of a new pattern for addition to the plurality of stored natural language patterns 135 residing in the data repository 130. The new pattern is defined using one or more of the plurality of stored natural language patterns 135. In some cases, the operation 240 is optional, and the method 200 may be performed without the operation 240.

At operation 250, the server 120 determines, based on the identified one or more word groups and the at least one stored natural language pattern, whether the text includes a grammatical error or inappropriate content and provides a corresponding output. The corresponding output represents whether the text includes the grammatical error and/or whether the text includes the inappropriate content. In some cases, the operation 250 is optional, and the method 200 may be performed without the operation 250.

In some cases, the server 120 determines (e.g., at operation 250), based on the identified one or more word groups and the at least one stored natural language pattern, that the text includes a grammatical error. The server 120 provides an output representing the grammatical error.

In some cases, the server 120 determines (e.g., at operation 250), based on the identified one or more word groups and the at least one stored natural language pattern, that the text includes inappropriate content. The server provides an output representing the inappropriate content. The inappropriate content may be, for example, hate speech that disparages a certain marginalized group of people or pornographic content having a lewd or inappropriately sexual nature.

In some cases, a specific stored natural language pattern 135 is represented, within the data repository, as a plaintext file that includes a list of word or a reference to another stored natural language pattern.

In some cases, a specific stored natural language pattern 135 from the plurality of stored natural language patterns 135 identifies one or more words that are excluded, and one or more words or one or more sub-patterns that are required. The identified one or more words that are excluded are not present in a word group corresponding to the specific stored natural language pattern 135. The identified one or more words or one or more sub-patterns that are required are present in the word group corresponding to the specific stored natural language pattern 135.

In some cases, a specific stored natural language pattern 135 from the plurality of stored natural language patterns 135 identifies one or more other stored natural language patterns that are excluded. The identified one or more other stored natural language patterns are not present in a word group corresponding to the specific stored natural language pattern 135. In one example, the specific stored natural language pattern identifies at least one exclusion exception pattern. The at least one exclusion exception pattern corresponds to the one or more other stored natural language patterns that are excluded, but the at least one exclusion exception pattern is present in the word group corresponding to the specific stored natural language pattern 135.

In some cases, a specific stored natural language pattern 135 from the plurality of stored natural language patterns 135 identifies one or more other stored natural language patterns that are required. The identified one or more other stored natural language patterns are present in a word group corresponding to the specific stored natural language pattern.

In some cases, a specific stored natural language pattern 135 identifies an order of two or more other stored natural language patterns within the specific stored natural language pattern 135 within word groups corresponding to the specific stored natural language pattern 135.

In some cases, a specific stored natural language pattern 135 identifies two or more other stored natural language patterns within the specific stored natural language pattern without specifying an order for the two or more other stored natural language patterns within word groups corresponding to the specific stored natural language pattern 135.

In the artificial intelligence-based content generation context, implementations of the technology may be useful. For example, an artificial intelligence “bot” that communicates with a human user may receive input (e.g., text or speech converted to text) from a human. The bot may benefit from understanding whether the human is making a statement that is inappropriate (e.g., strongly related to sexuality or “hate speech”) in order to appropriately respond to the human. In addition, the bot may benefit from understanding the context of the human's speech in order to respond appropriately. For example, in technical support for a consumer product, the bot may respond to the human differently if the human is saying something inappropriate, if the human is calling to learn how to use the product, if the human is requesting to return the product, and if the human is trying to make a warranty-related claim.

It should be noted that, while the operations 210-250 of the method 200 are specified as being performed in a certain order, in some examples, the operations 210-250 may be performed in a different order. In some cases, one or more of the operations 210-250 may be skipped.

FIG. 3 illustrates some example first person natural language patterns 300, in accordance with some embodiments. As shown, the example first person natural language patterns include the first person singular pattern 330, which includes the set {“I”, “me”}. The first person plural pattern 340 includes the set {“us”, “we”}. The first person pattern 320 includes the combination of the first person singular pattern 330 and the first person plural pattern 340—{“I”, “me”, “us”, “we”}. The first person non-objective pattern 310 includes the first person pattern 340 but excludes the set 350 {“me”, “us”}. Thus, the first person non-objective pattern 310 includes the set {“I”, “we”}. Natural language patterns may be defined in the form shown in FIG. 3, for example, using text file(s), inclusion link(s), and/or exclusion link(s).

According to some examples, defining the natural language patterns 300 of FIG. 3 (and similar patterns) may include the following order of operations: (1) get values from word group sources, (2) combine with standalone terms, (3) remove values defined in excluded word group sources, and (4) remove standalone excluded terms. The natural language patterns 300 may be defined using one or more of: related text values, standalone terms, word sources, and excluded values.

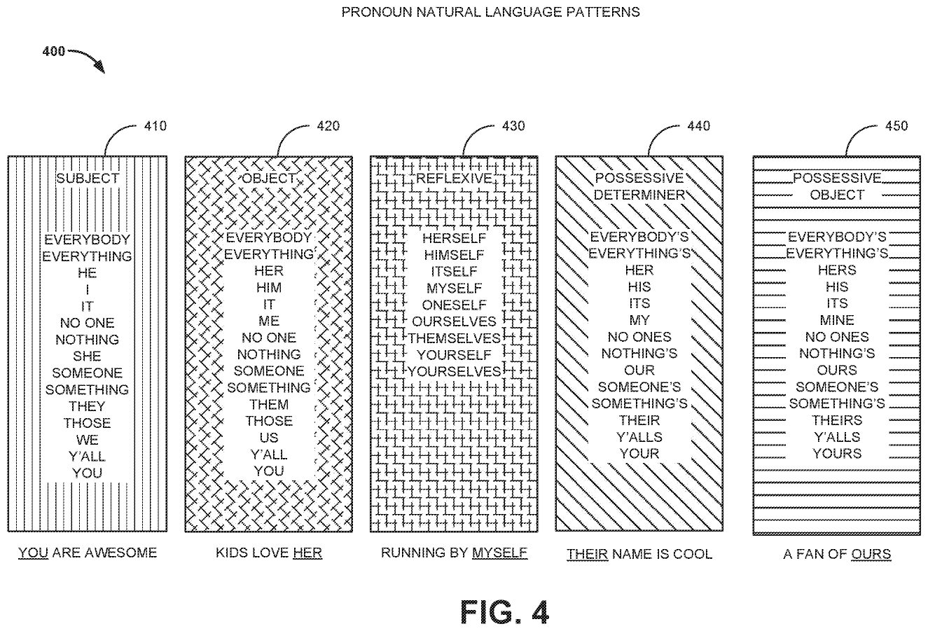

FIG. 4 illustrates some example pronoun natural language patterns 400, in accordance with some embodiments. The pronoun natural language patterns 400 are patterns that represent pronouns. For example, the pronoun natural language patterns, include a subject pattern 410, an object pattern 420, a reflexive pattern 430, a possessive determiner pattern 440, and a possessive object pattern 450. The pronoun natural language patterns 400 are based on different words that represent different types of pronouns, and capture equivalent variations of a given type of pronoun. The variations may or may not be grammatically correct. For example, the second person pronoun in the English language may include: “you”, “u”, “ya”, “yew”, “yu”, and the like. A pronoun natural language pattern may specify which adjective variations should be supported (e.g., adjective are required, adjectives are excluded, minimum number of adjectives, and/or maximum number of adjectives). The pronoun natural language pattern may specify if determiners or prepositions are supported. For example, pronoun natural language patterns 400 may correspond to the following: “my”, “me”, “all of him”, “behind stupid you”, and the like.

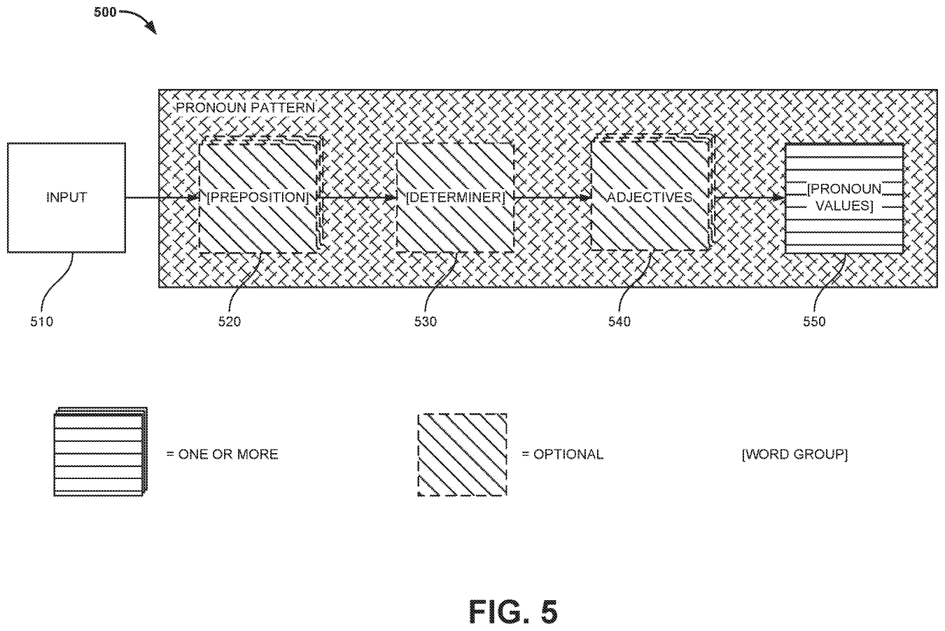

FIG. 5 illustrates an additional example pronoun natural language pattern 500, in accordance with some embodiments. As shown, in the additional example pronoun natural language pattern 500, an input 510 is mapped to optional one or more prepositions 520, an optional determiner 530, optional one or more adjectives 540, and pronoun value(s) 550.

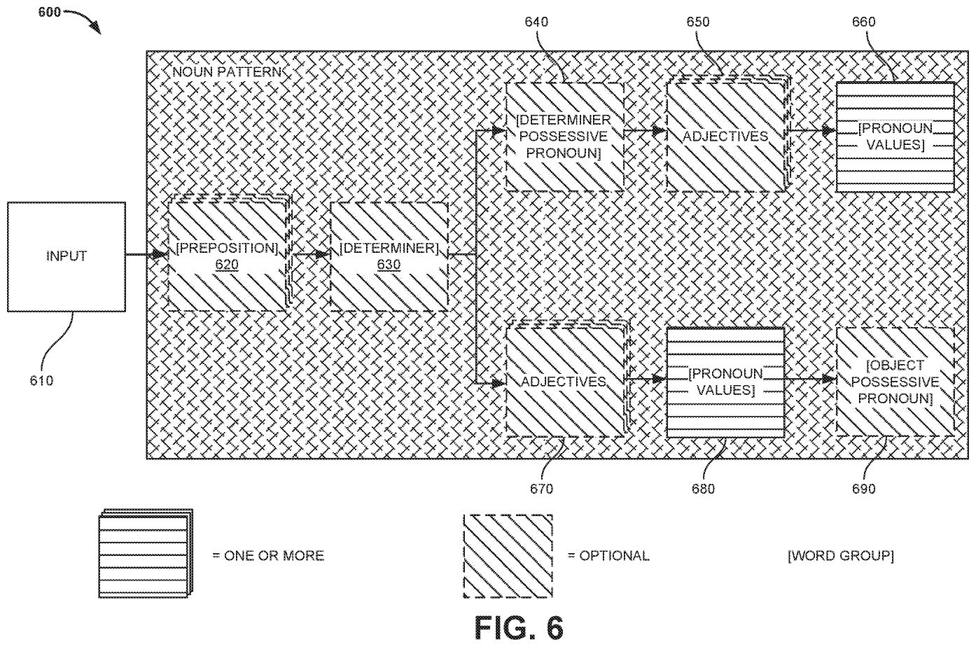

FIG. 6 illustrates an example noun natural language pattern 600, in accordance with some embodiments. The noun natural language pattern 600 may represent a noun or a pronoun. The noun natural language pattern 600 may specify one or more words or patterns that represent the noun. The noun natural language pattern 600 may specify if the possessive forms should be supported. Possessive forms specify if the noun is the subject of the possessive (e.g., “mom's”). In a possessive pronoun, the noun is the object of the possession. It may support the determiner possessive form, such as “my mom” or it may support the object possessive form, such as “mom of mine.” The noun natural language pattern 600 may specify which forms are required. The noun natural language pattern 600 may specify what adjective variations should be supported (e.g., adjectives are required, adjectives are excluded, minimum number of adjectives, and/or maximum number of adjectives). The noun natural language pattern 600 may specify if determiners or prepositions are supported. Variations of the noun natural language pattern 600 include: “shoes”, “some of my shirt”, “all over those pants”, and “my red and blue hats”.

As shown in FIG. 6, in the noun natural language pattern 600, an input 610 is mapped to an optional preposition 620 and an optional determiner 630. Then, the noun natural pattern branches into either a first branch or a second branch. The first branch includes an optional determiner possessive pronoun 640, optional adjectives 650, and pronoun value(s) 660. The second branch includes optional adjectives 670, pronoun value(s) 680, and an optional object possessive pronoun 690.

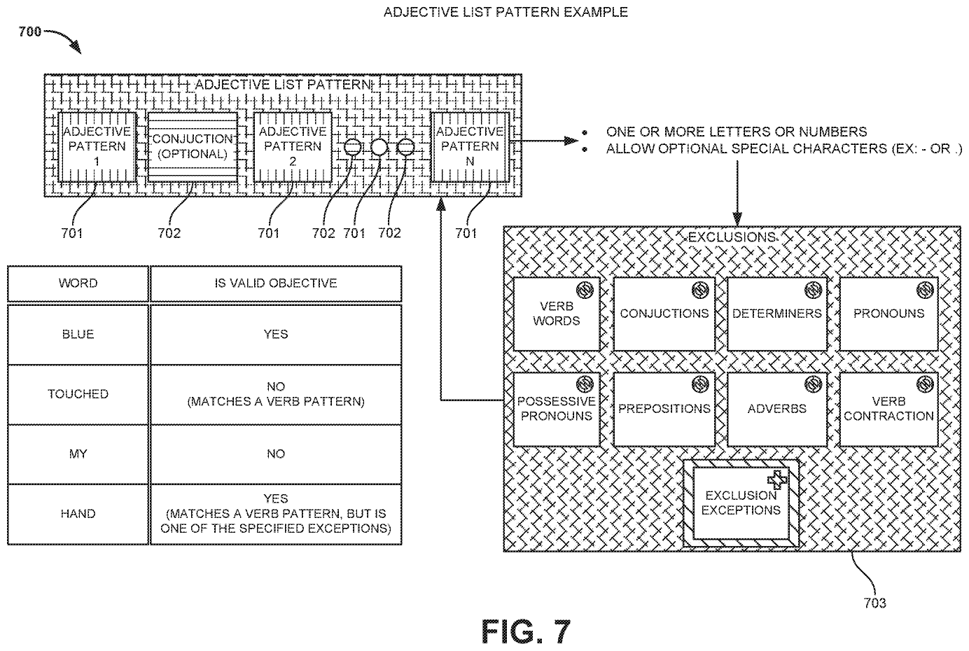

FIG. 7 illustrates an example adjective list pattern 700, in accordance with some embodiments. This natural language pattern represents one or more adjectives. Adjectives may be defined as word(s) that are not excluded by other specific natural language patterns. Adjectives may be identified based on context. For example in “my hand scar” the word “hand” is an adjective. However, in “hand me the paper” or “my dominant hand” the word “hand” is not an adjective but a verb or a noun, respectively. Words that are excluded from the adjective natural language pattern include: the verb conjugation natural language pattern, and the conjunction natural language pattern (e.g., “and”, “or”, “but”). However, if there is more than one adjective, a single conjunction may be allowed between them (e.g. “cute, soft, and red shirt”). Words that are excluded from the adjective natural language pattern include: the determiner natural language pattern (e.g., “a”, “an”, “the”, “those”), the pronoun natural language pattern, the possessive pronoun natural language pattern (e.g., “my”, “your”, “our”), the preposition natural language pattern (e.g., “in”, “against”, “on top of”), the adverb natural language pattern (e.g. “quickly”, “softly”), and verb contraction ending pattern (e.g., “they're”). In addition, words that are excluded from the adjective natural language pattern may include words that have a non-ambiguous contraction that lack an apostrophe. For example “Im” definitely corresponds to “I'm/I am,” whereas “shell” may correspond to either “she'll/she will” or “shell” (as in “snail shell” or “shell design”).

As shown, the adjective list pattern 700 includes adjectives 701 and conjunctions 702. A set of exclusions 703 is also specified.

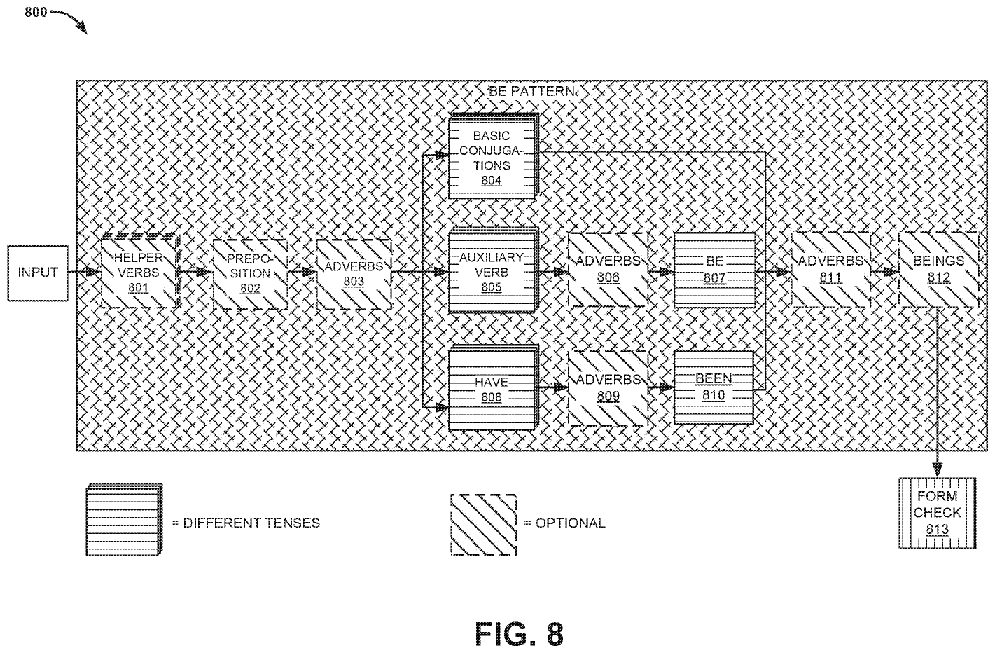

FIG. 8 illustrates an example “be” pattern 800, in accordance with some embodiments. The “be” pattern 800 represents various conjugations of the verb “be.” The “be” pattern 800 may specify one or more tenses (e.g., past, present, future) and one or more forms (e.g., positive, negative). The “be” pattern 800 specifies if adverbs can occur between parts of the various conjugation patterns. The “be” pattern 800 may include basic conjugations based on tenses (e.g., be, been, being, am, is, are, was, were, etc.). In some cases, if only the future tense is specified, then no basic conjugations are valid. Conjugations that can be represented as contractions are also included (e.g., she's=she is). The “be” pattern 800 may include auxiliary verbs based on tenses being added to “be,” such as “could be”, “might be”, and “will be”. Some auxiliary verbs may be represented as contractions (e.g., I'll be=I will be). The “be” pattern 800 may include the perfect tense (e.g., have been, should have been, should've been, etc.). The “be” pattern 800 may include the progressive tense, which includes any of the above patterns followed by being (e.g. is being, could be being, have been being, etc.).

The “be” pattern 800 may include helper verbs. The helper verbs include any other verb followed by the any pattern above (e.g., want to be, like being, etc.). If all the tenses are specified, an optional helper verb may be prefixed with all tenses before the patterns. Otherwise, an additional helper verb may be included in the same tenses, followed by the “be” pattern 800 with all tenses. The “be” pattern 800 may also specify whether helper verbs are required and whether all or only certain verbs qualify to be used as helper verbs.

The “be” pattern 800 may ensure (e.g., form check 813) that the pattern is honored after each evaluation of the pattern. For example, if the pattern is negative, the number of negative terms is odd (e.g., “don't want to be”, “want to not be”). If the pattern is positive, the number of negative terms should be even (e.g., “want to be”, “don't want to not be”).

As shown, the “be” pattern 800 includes optional helper verbs 801, an optional preposition 802, and optional adverbs 803. This is followed by either (i) a basic conjugation 804, (ii) auxiliary verb(s) 805, optional adverb(s) 806, and be 807, or (iii) have 808, optional adverb(s) 809, and been 810. This is followed by optional adverb(s) 811, and being 812.

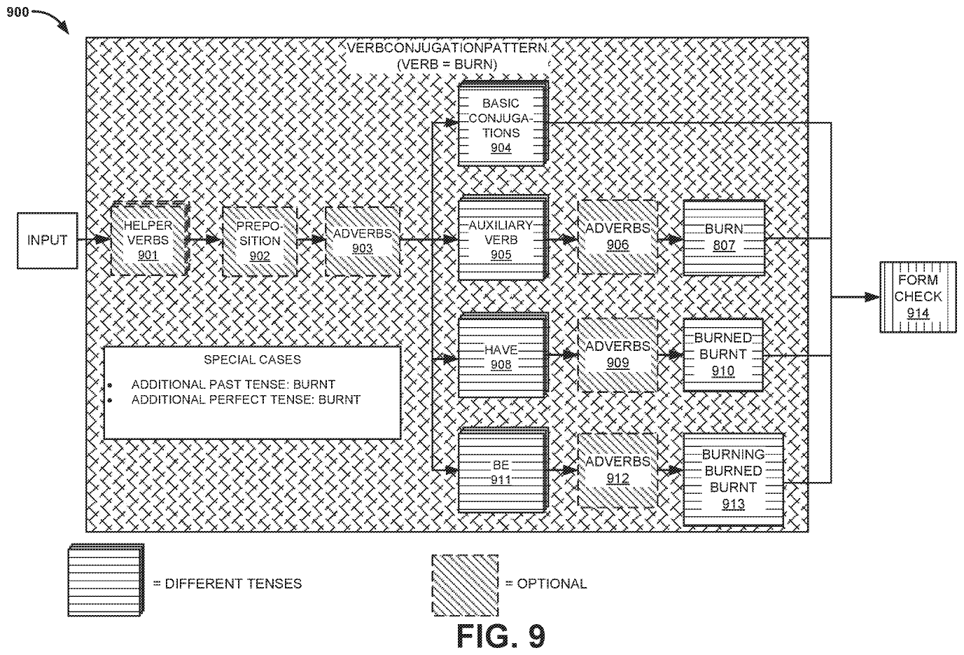

FIG. 9 illustrates an example single verb conjugation pattern 900, in accordance with some embodiments. This pattern represents all conjugations of a verb. It may specify the base form of the verb and special conjugation cases, such as double consonant (e.g., rub/rubbed) or dropping the e (e.g., hope/hoping). Irregular conjugations may also be specified (e.g., show/shown). The verb conjugation pattern 900 may specify one or more tenses (e.g., past, present, future) and/or one or more forms (e.g., positive, negative). The verb conjugation pattern 900 specifies if adverbs can occur between parts of the verb conjugation patterns.

The verb conjugation pattern 900 may include a basic conjugation pattern based on tenses (e.g., kick, kicks, kicked, kicking). If only the future tense is specified, then no basic conjugations are valid. Conjugations that may be represented as contractions (e.g., I have=I've) may be included. The verb conjugation pattern 900 may include auxiliary verb(s) based on tenses followed by the base form (e.g., could kick, might kick, will kick). Some auxiliary verbs may be represented as a contraction (e.g., I will kick=I'll kick). The verb conjugation pattern 900 may include a form of have based on tenses followed by the past, irregular, or perfect tense (e.g., have kicked, should have kicked, should've kicked). The verb conjugation pattern 900 may include a form of“be” followed by the gerund, past or irregular perfect tense of the verb (e.g., is kicking, was kicked).

The verb conjugation pattern 900 may include helper verbs—any other verb followed by any pattern above (e.g., want to be kicked, likes kicking). If all the tenses are specified, an optional helper verb pattern may be prefixed with all tenses before the pattern. Otherwise, an additional helper verb with the same tenses may be followed by a “be” pattern with all tenses. Optional prepositions may be included immediately before the helper verb(s). The verb conjugation pattern 900 may specify whether helper verbs are required and whether all or certain verbs should be used.

The verb conjugation pattern may ensure (e.g., form check 914) that the pattern form is honored after each evaluation of the pattern. If a negative tense is used, the number of negative terms should be odd. If a positive tense is used, the number of negative terms should be even (e.g., zero).

As shown, the verb conjugation pattern 900 includes optional helper verbs 901, an optional preposition 902, and optional adverbs 903. This is followed by either (i) basic conjugation(s) 904, (ii) auxiliary verb(s) 905, optional adverb(s) 906, and burn 907, (iii) have 908, optional adverb(s) 909, and burned/burnt 910, or (iv) be 911, optional adverb(s) 912, and burning/burned/burnt 913.

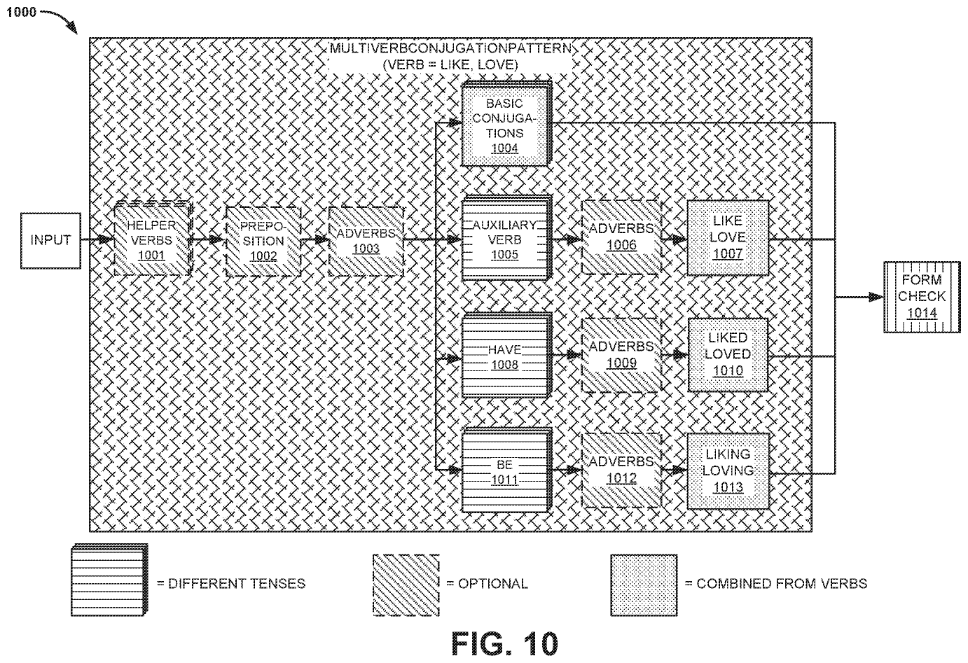

FIG. 10 illustrates an example multiple verb conjugation pattern 1000, in accordance with some embodiments. The multiple verb conjugation pattern 1000 is a pattern that represents all conjugations of multiple verbs. Some aspects optimize the pattern matching by consolidating common conjugation logic. Some aspects specify one or more tenses. Some aspects specify one or more forms (e.g., positive, negative). Some aspects specify if adverbs can occur between parts of the various conjugation patterns.

As shown, the multiple verb conjugation pattern 1000 includes optional helper verb(s) 1001, followed by an optional preposition 1002, followed by optional adverbs 1003. This is followed by either (i) basic conjugations 1004, (ii) auxiliary verb(s) 1005, followed by optional adverb(s) 1006, followed by like/love 1007, (iii) have 1008, followed by optional adverb(s) 1009, followed by liked/loved 1010, or (iv) be 1011, followed by optional adverb(s) 1012, followed by liking/loving 1013.

Some aspects include basic conjugations of each verb. In some cases, if only the future tense is specified, then no basic conjugations are valid. In some cases, auxiliary verbs are based on tenses, followed by the base form of each verb. Some aspects include auxiliary verbs that can be represented as a contraction (e.g., she will=she'll). Some aspects include form of “have” based on tenses, followed by the past or irregular perfect of each verb. Some aspects include forms of “be” based on tenses, followed by the gerund, past or irregular perfect of each verb.

Some aspects include helper verbs—any other verb followed by any of the above patterns. If all tenses are specified, an optional helper verb pattern may be prefixed with all tenses before the pattern. Otherwise, an additional helper verb with the tenses may be included, followed by a “be” pattern with all tenses. Optionally, prepositions may be included immediately after the helper verb. The verb conjugation pattern 1000 may also specify if helper verbs are required and whether all or only certain specified helper verbs should be used.

After the evaluation of each pattern, some aspects ensure (form check 1014) that the pattern form is honored. If the pattern form is negative, the number of negative words should be odd. If the pattern form is positive, the number of negative words should be even (e.g., zero).

According to some examples, a general pattern includes a pattern that represents the majority of cases in the grammar of a natural language (e.g., English or French). The general pattern may include one or more parts, which can be combined to handle a complex pattern. The general pattern may specify a pattern type, which controls the logic for combining the parts. For example, a single part pattern is represented by a single part. In a sequential match pattern, parts are evaluated in order, as is, to match the text. In a phrase pattern, parts are evaluated as a phrase that is constructed using the parts as anchor points. In a broad match pattern, the pattern broadly matches the text based on the various specified parts.

Each part may represent a part of speech or a custom pattern. For example, the pattern “none” represents no part of speech. It is just a standalone set of values or pattern references. The pattern “pronoun” may include one or more of the pronoun natural language patterns 410, 420, 430, 440, and 450 shown in FIG. 4. The pattern “noun” may include an instance of the noun pattern. The pattern “verb” may include an instance of the verb conjugation pattern. The pattern “custom” may include a pattern that represents a custom part of speech.

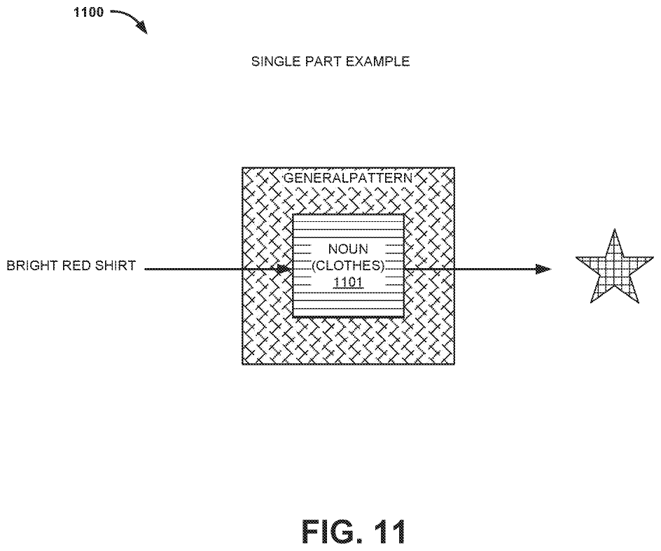

FIG. 11 illustrates an example single part pattern 1100, in accordance with some embodiments. As shown in FIG. 11, the text, “bright red shirt,” corresponds to the general pattern “noun (clothes)” 1101, as it is a noun pattern associated with clothes.

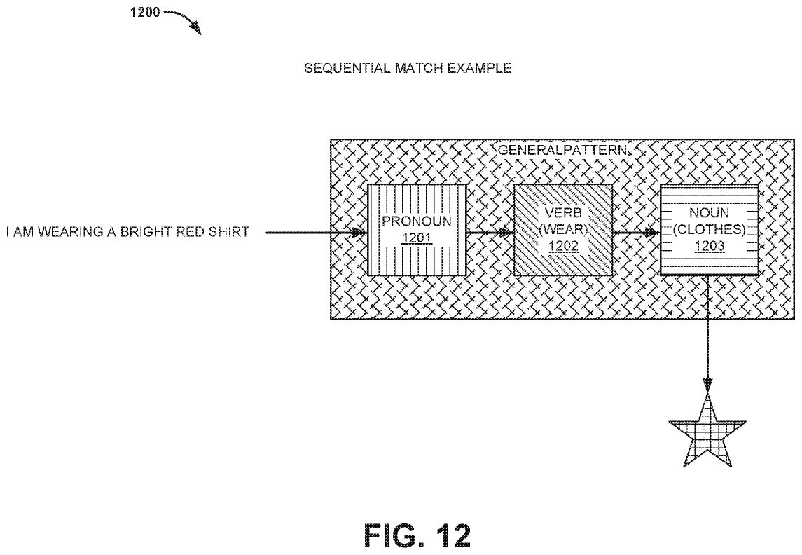

FIG. 12 illustrates an example sequential match pattern 1200, in accordance with some embodiments. As shown in FIG. 12, the text “I am wearing a bright red shirt,” maps to the sequential pattern {Pronoun 1201, Verb (wear) 1202, Noun (clothes) 1203} because “I” is a pronoun pattern, “am wearing” is a verb pattern of the verb wear, and “a bright red shirt” is a noun pattern associated with clothes.

A phrase pattern may add common, operational variations between the parts. For example, adverbs, prepositions, conjugations, and the like may be added. The type and variation may be based on the sequence of verb and non-verb parts. Different phrase types (e.g., question, statement) may be supported. Different phrase forms (e.g., positive, negative) may be supported.

The start of the phrase may be added based on the phrase type. For example, statements may be formed using adverbs or prepositions. A preposition or an adverb may be added at the start of the pattern (e.g., to handle all order permutations). The pattern may be added for the first part. Questions may be formed using question words (e.g., who, what, how, etc.) basic be verbs, basic have verbs, auxiliary verbs, and/or adverbs. In some cases, the technology describes herein ensures that the first part is not a verb (as, in some cases, a question cannot start with a verb). Patterns may be added to handle different options for how a question can start. For example, a question may start with a question word. In some cases, a question has an optional question word, followed by an optional adverb, then an auxiliary or a form of be or have. Examples include: Why are you crying? Have you heard the news? When did you eat that? How quickly can you come over? Are you feeling better? Should I stay at home? Why is your brother crying?

When adding the remaining parts, phrase-specific variations may be handled. Optional conjugations, adverbs, and/or prepositions may be added. If the next part is the second part (a verb that contains be), and the phrase is a question, that part may be optional. For example, in “I am tired,” a form of“be” is required between “I” and “tired.” In “Why am I tired?” a form of “be” is also required. However, no form of be is required in “I feel tired.” However, if this is changed into a why question—“Why am I feeling tired?”—a form of “be” is used. In addition, proper spacing may be handled. Spaces before verbs may be optional to handle contractions. In addition, special spacing cases may be handled (e.g., “Let me help you!/Lemme help you!”, “Are you coming?/Ru coming?”). In some cases, a preposition and an adverb may be added at the end of the pattern.

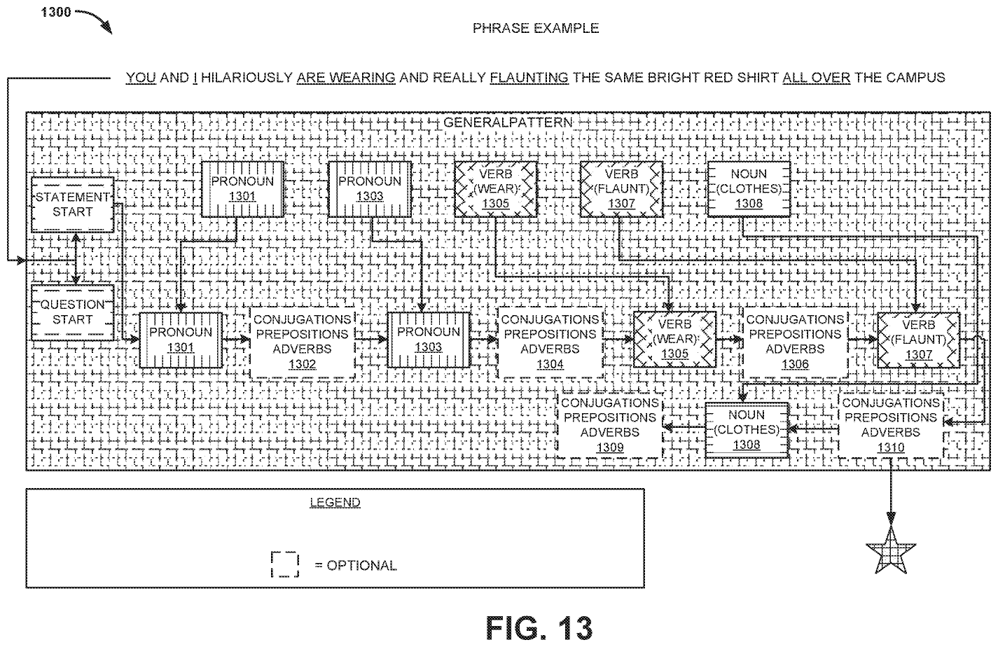

FIG. 13 illustrates an example phrase natural language pattern 1300, in accordance with some embodiments. As shown, the phrase is: “You and I hilariously are wearing and really flaunting the same bright red shirt all over the campus.” In this phrase, “You” is mapped to a pronoun 1301. “And” is mapped to a conjunction 1302. “I” is mapped to a pronoun 1303. “Hilariously” is mapped to an adverb 1304. “Are wearing” is mapped to a verb (wear) 1305. “And really” are mapped to a conjunction and adverb 1306. “Flaunting” is mapped to a verb (flaunt) 1307. “The same bright red shirt” is mapped to a noun (clothes) 1308. “All over” is mapped to a preposition 1309, before the noun “the campus.” It should be noted that the conjunctions, prepositions, and adverbs above are optional. For example, nothing is mapped to the optional conjunctions/prepositions/adverbs 1310.

In a broad match natural language pattern, text is matched with a certain number of parts that can evaluate the text. The broad match natural language pattern may specify what type of text can separate the parts. The default may be a configurable number of optional words that are separated by a space. The programmer can specify a custom pattern that can be used to separate the broad match parts. The programmer can specify whether or not the order of the parts matters. The broad match natural language pattern may handle all order permutations of the parts and/or specify the minimum and maximum number of parts that need to occur.

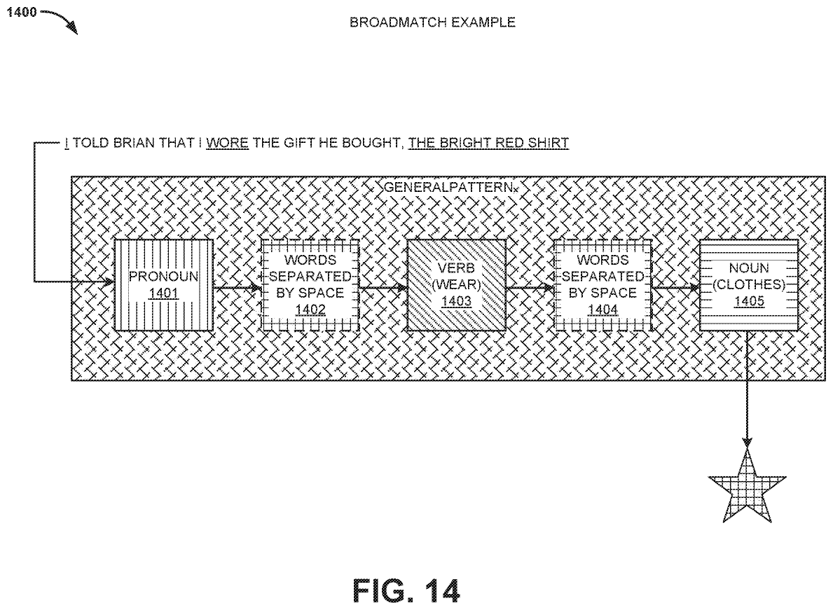

FIG. 14 illustrates an example broad match natural language pattern 1400, in accordance with some embodiments. As shown, the broad match natural language pattern 1400 requires a pronoun 1401, a verb (wear) 1403, and a noun (clothes) 1405. This pattern 1400 may be used to describe what someone is wearing. There are optional other words separated by spaces 1402 and 1404, between the pronoun 1401 and the verb (wear) 1403, and between the verb (wear) 1403 and the noun clothes (1405), respectively. In the text: “I told Brian that I wore the gift he bought, the bright red shirt,” the pronoun 1401 corresponds to “I.” The verb (wear) 1403 corresponds to “wore.” The noun (clothes) 1405 corresponds to “the bright red shirt.” The words separated by space 1402 correspond to “told Brian that I,” and the words separated by space 1404 correspond to “the gift he bought.”

Some natural language patterns may include criteria such as exclusions and/or requirements. These are used to refine logic about whether or not text matched to a pattern is valid. Criteria values may be based on patterns, word groups, or standalone terms.

Criteria may specify one or more of the following positions. “Contains” criteria check if the text contains one of the specified values. (E.g., A sentence contains a noun and a verb.) “Starts with” criteria check if the text starts with one of the specified values. (E.g., A question about location starts with “Where.”) “Ends with” criteria check if the text ends with one of the specified values. “Exact match” criteria check if the text is the same as one of the specified values. In some cases, to support optional values, it can be checked whether one of the specified values starts before the start of the text or ends after the end of the text. “Before match” criteria check if the text is immediately preceded by one of the specified values. In some cases, to support optional values, it can be checked whether one of the specified values starts before the start of the text or extends past the start of the text. “After match” criteria check if the text is immediately followed by one of the specified values. In some cases, to support optional values, it can be checked whether one of the specified values starts within the text or extends past the end of the text.

One or more criteria may be specified on any natural language pattern (or any part of a natural language pattern). Matches are not valid if any of the exclusions are satisfied or if all of the requirements are not satisfied. For a match to be valid, all of the requirements are satisfied, and none of the exclusions are satisfied.

In an example of an exclusion, in asking whether a person is a Christian, the text “named” may correspond to an exclusion. For instance, in the text, “Are you named Christian?” the speaker is not asking the listener if he is a Christian. A statement about a person being tired may have exclusions for the terms “if” and “rarely,” for example, in “If I am tired, I will let you know,” and “Rarely am I tired this early at night.” In another example, a statement about a person hating a country or nationality have exclusions for the word “food” and names of songs, musicians, artists, etc. For example, “I do not like Chinese food from that restaurant,” does not indicate dislike for the country of China. Similarly, “I hate that Portugal the Man song,” expresses dislike for a song by the rock band “Portugal the Man,” not the country of Portugal.

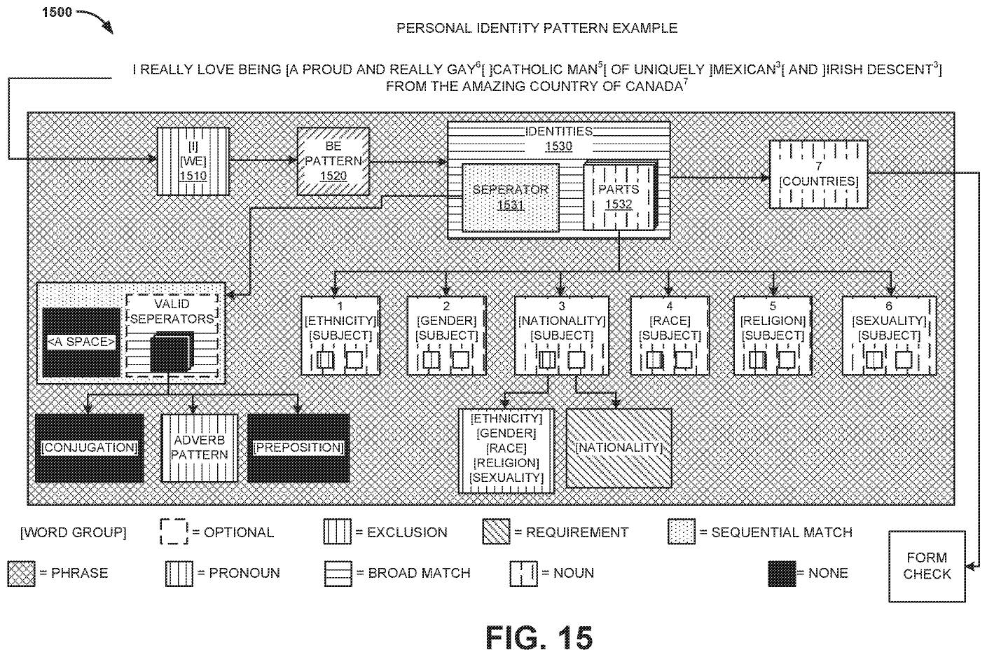

FIG. 15 illustrates an example personal identity natural language pattern 1500, in accordance with some embodiments. As shown, the personal identity natural language pattern 1500 includes a first person non-objective pronoun 1510 (“I” or “we”), followed by a “be” pattern 1520 (examples are described in detail in conjunction with FIG. 8), followed by identities 1530, followed by an optional country 7. The identities 1530 include separators 1531 and parts 1532. The parts 1532 may include ethnicity 1, gender 2, nationality 3, race 4, religion 5, and/or sexuality 6. The separator 1531 corresponds to a space followed by valid separators—conjunction(s), adverb pattern(s), and/or prepositions.

As illustrated in FIG. 15, the sentence “I really love being a proud and really gay Catholic man of uniquely Mexican and Irish descent from the amazing country of Canada,” is mapped to the personal identity natural language pattern 1500. “I” corresponds to the first person non-objective pronoun 1510. “Really” corresponds to a separator in a phrase pattern, similar to the adverb 1306 of FIG. 13. “Love being” corresponds to the “be” pattern 1520. “A proud and really gay Catholic man of uniquely Mexican and Irish descent” corresponds to the identities 1530. Within these identities, the part 1532 “a proud and really gay” corresponds to the sexuality 6. It is followed by a separator 1531 (space). The part 1532 “Catholic man” corresponds to the religion 5. The separator 1532 “of uniquely” includes the conjunction “of” and the adverb pattern “uniquely.” The part 1532 “Mexican” corresponds to the nationality 3. The separator 1531 “and” is a conjunction. The part 1532 “Irish descent” corresponds to the nationality 3. “From” corresponds to a separator in a phrase pattern, similar to the adverb 1306 of FIG. 13. “The amazing country of Canada” corresponds to the country 7.

It should be noted that, to the extent that implementations of the technology described herein includes gathering personal information of users of computing devices, the information is only stored if the user providing the information (and/or another user associated with the information) provides affirmative consent for the storage of such information. Persistent reminders (e.g., weekly emails or icons on mobile device interfaces) may be provided to users notifying them that their personal information is being stored or accessed. A user may opt-out of having his/her personal information stored at any time.

The technology described herein relates to identifying and processing natural language patterns in text. This technology may be useful in multiple different contexts for understanding and/or processing human speech or text typed by humans. Some example use case include spelling and grammar checks in word processing software, or in identifying inappropriate content (e.g., sexual content or content that may be offensive to certain groups of people) in communication with a chat bot or within a social networking service. For example, a social networking service may wish to exclude posts that describe something as being “gay” in a negative manner (e.g., “That television show is gay.”) but allow personal identity statements that describe oneself as being gay (e.g., “I really love being a proud and really gay Catholic man.”). Advantageously, some aspects of the technology described herein, allow such fine-tuned processing and analysis of natural language text.

### NUMBERED EXAMPLES

Certain embodiments are described herein as numbered examples 1, 2, 3, etc. These numbered examples are provided as examples only and do not limit the subject technology.

Example 1 is a method comprising: accessing, via an electronic transmission, a text in a natural language, identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language; and providing an output representing the identified one or more word groups and the at least one stored natural language pattern corresponding to each of the identified one or more word groups.

In Example 2, the subject matter of Example 1 includes, receiving, as input, a representation of a new pattern for addition to the plurality of stored natural language patterns residing in the data repository, wherein the new pattern is defined using one or more of the plurality of stored natural language patterns.

In Example 3, the subject matter of Examples 1-2 includes, wherein a specific stored natural language pattern is represented, within the data repository as a plaintext file that includes a list of word or a reference to another stored natural language pattern.

In Example 4, the subject matter of Examples 1-3 includes, wherein a specific stored natural language pattern from the plurality of stored natural language patterns identifies one or more words that are excluded, and one or more words or one or more sub-patterns that are required, wherein the identified one or more words that are excluded are not present in a word group corresponding to the specific stored natural language pattern, and wherein the identified one or more words or one or more sub-patterns that are required are present in the word group corresponding to the specific stored natural language pattern.

In Example 5, the subject matter of Examples 1-4 includes, wherein a specific stored natural language pattern from the plurality of stored natural language patterns identifies one or more other stored natural language patterns that are excluded, and wherein the identified one or more other stored natural language patterns are not present in a word group corresponding to the specific stored natural language pattern.

In Example 6, the subject matter of Example 5 includes, wherein the specific stored natural language pattern identifies at least one exclusion exception pattern, wherein the at least one exclusion exception pattern corresponds to the one or more other stored natural language patterns that are excluded, but wherein the at least one exclusion exception pattern is present in the word group corresponding to the specific stored natural language pattern.

In Example 7, the subject matter of Examples 1-6 includes, wherein a specific stored natural language pattern from the plurality of stored natural language patterns identifies one or more other stored natural language patterns that are required, and wherein the identified one or more other stored natural language patterns are present in a word group corresponding to the specific stored natural language pattern.

In Example 8, the subject matter of Examples 1-7 includes, wherein a specific stored natural language pattern identifies an order of two or more other stored natural language patterns within the specific stored natural language pattern within word groups corresponding to the specific stored natural language pattern.

In Example 9, the subject matter of Examples 1-8 includes, wherein a specific stored natural language pattern identifies two or more other stored natural language patterns within the specific stored natural language pattern without specifying an order for the two or more other stored natural language patterns within word groups corresponding to the specific stored natural language pattern.

In Example 10, the subject matter of Examples 1-9 includes, wherein the word-phrase type comprises a numerical text.

Example 11 is a non-transitory machine-readable medium storing instructions which, when executed by one or more machines, cause the one or more machines to perform operations comprising: accessing, via an electronic transmission, a text in a natural language; identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language; and providing an output representing the identified one or more word groups and the at least one stored natural language pattern corresponding to each of the identified one or more word groups.

In Example 12, the subject matter of Example 11 includes, the operations further comprising: receiving, as input, a representation of a new pattern for addition to the plurality of stored natural language patterns residing in the data repository, wherein the new pattern is defined using one or more of the plurality of stored natural language patterns.

In Example 13, the subject matter of Examples 11-12 includes, wherein a specific stored natural language pattern is represented, within the data repository as a plaintext file that includes a list of word or a reference to another stored natural language pattern.

In Example 14, the subject matter of Examples 11-13 includes, wherein a specific stored natural language pattern from the plurality of stored natural language patterns identifies one or more words that are excluded, and one or more words or one or more sub-patterns that are required, wherein the identified one or more words that are excluded are not present in a word group corresponding to the specific stored natural language pattern, and wherein the identified one or more words or one or more sub-patterns that are required are present in the word group corresponding to the specific stored natural language pattern.

In Example 15, the subject matter of Examples 11-14 includes, wherein a specific stored natural language pattern from the plurality of stored natural language patterns identifies one or more other stored natural language patterns that are excluded, and wherein the identified one or more other stored natural language patterns are not present in a word group corresponding to the specific stored natural language pattern.

In Example 16, the subject matter of Example 15 includes, wherein the specific stored natural language pattern identifies at least one exclusion exception pattern, wherein the at least one exclusion exception pattern corresponds to the one or more other stored natural language patterns that are excluded, but wherein the at least one exclusion exception pattern is present in the word group corresponding to the specific stored natural language pattern.

In Example 17, the subject matter of Examples 11-16 includes, wherein a specific stored natural language pattern from the plurality of stored natural language patterns identifies one or more other stored natural language patterns that are required, and wherein the identified one or more other stored natural language patterns are present in a word group corresponding to the specific stored natural language pattern.

In Example 18, the subject matter of Examples 11-17 includes, wherein a specific stored natural language pattern identifies an order of two or more other stored natural language patterns within the specific stored natural language pattern within word groups corresponding to the specific stored natural language pattern.

In Example 19, the subject matter of Examples 11-18 includes, wherein a specific stored natural language pattern identifies two or more other stored natural language patterns within the specific stored natural language pattern without specifying an order for the two or more other stored natural language patterns within word groups corresponding to the specific stored natural language pattern.

Example 20 is a system comprising: processing hardware; and a memory storing instructions which, when executed by the processing hardware, cause the processing hardware to perform operations comprising: accessing, via an electronic transmission, a text in a natural language; identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language; and providing an output representing the identified one or more word groups and the at least one stored natural language pattern corresponding to each of the identified one or more word groups.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Components and Logic

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that an record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components might not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

### Example Machine and Software Architecture

The components, methods, applications, and so forth described in conjunction with FIGS. 1-15 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the disclosed subject matter in different contexts from the disclosure contained herein.

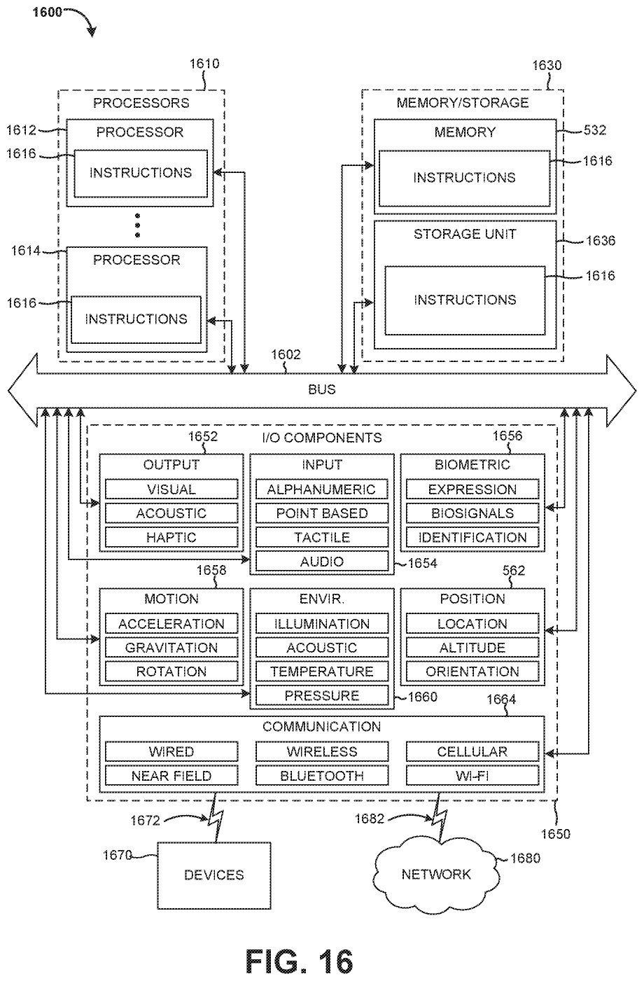

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1616 (e.g., software, a program, an application, an applet, an app, or other executable code) for causing the machine 1600 to perform any one or more of the methodologies discussed herein may be executed. The instructions 1616 transform the general, non-programmed machine into a particular machine programmed to carry out the described and illustrated functions in the manner described. In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1616, sequentially or otherwise, that specify actions to be taken by the machine 1600. Further, while only a single machine 1600 is illustrated, the term “machine” shall also be taken to include a collection of machines 1600 that individually or jointly execute the instructions 1616 to perform any one or more of the methodologies discussed herein.

The machine 1600 may include processors 1610, memory/storage 1630, and I/O components 1650, which may be configured to communicate with each other such as via a bus 1602. In an example embodiment, the processors 1610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1612 and a processor 1614 that may execute the instructions 1616. The term “processor” is intended to include multi-core processors that may comprise two or more independent processors (sometimes referred to as “cores”) that may execute instructions contemporaneously. Although FIG. 16 shows multiple processors 1610, the machine 1600 may include a single processor with a single core, a single processor with multiple cores (e.g., a multi-core processor), multiple processors with a single core, multiple processors with multiples cores, or any combination thereof.

The memory/storage 1630 may include a memory 1632, such as a main memory, or other memory storage, and a storage unit 1636, both accessible to the processors 1610 such as via the bus 1602. The storage unit 1636 and memory 1632 store the instructions 1616 embodying any one or more of the methodologies or functions described herein. The instructions 1616 may also reside, completely or partially, within the memory 1632, within the storage unit 1636, within at least one of the processors 1610 (e.g., within the processor's cache memory), or any suitable combination thereof, during execution thereof by the machine 1600. Accordingly, the memory 1632, the storage unit 1636, and the memory of the processors 1610 are examples of machine-readable media.

As used herein, “machine-readable medium” means a device able to store instructions (e.g., instructions 1616) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1616. The term “machine-readable medium” shall also be taken to include any medium, or combination of multiple media, that is capable of storing instructions (e.g., instructions 1616) for execution by a machine (e.g., machine 1600), such that the instructions, when executed by one or more processors of the machine (e.g., processors 1610), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1650 may include a wide variety of components to receive input, provide output, produce output, transmit information, exchange information, capture measurements, and so on. The specific I/O components 1650 that are included in a particular machine will depend on the type of machine. For example, portable machines such as mobile phones will likely include a touch input device or other such input mechanisms, while a headless server machine will likely not include such a touch input device. It will be appreciated that the I/O components 1650 may include many other components that are not shown in FIG. 16. The I/O components 1650 are grouped according to functionality merely for simplifying the following discussion and the grouping is in no way limiting. In various example embodiments, the I/O components 1650 may include output components 1652 and input components 1654. The output components 1652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1650 may include biometric components 1656, motion components 1658, environmental components 1660, or position components 1662, among a wide array of other components. For example, the biometric components 1656 may include components to detect expressions (e.g., hand expressions, facial expressions, vocal expressions, body gestures, or eye tracking), measure biosignals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 1658 may include acceleration sensor components (e.g., accelerometer), gravitation sensor components, rotation sensor components (e.g., gyroscope), and so forth. The environmental components 1660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1650 may include communication components 1664 operable to couple the machine 1600 to a network 1680 or devices 1670 via a coupling 1682 and a coupling 1672, respectively. For example, the communication components 1664 may include a network interface component or other suitable device to interface with the network 1680. In further examples, the communication components 1664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1670 may be another machine or any of a wide variety of peripheral devices (e.g., a peripheral device coupled via a USB).

Moreover, the communication components 1664 may detect identifiers or include components operable to detect identifiers. For example, the communication components 1664 may include Radio Frequency Identification (RFID) tag reader components, NFC smart tag detection components, optical reader components, or acoustic detection components (e.g., microphones to identify tagged audio signals). In addition, a variety of information may be derived via the communication components 1664, such as location via Internet Protocol (IP) geolocation, location via Wi-Fi® signal triangulation, location via detecting an NFC beacon signal that may indicate a particular location, and so forth.

In various example embodiments, one or more portions of the network 1680 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1680 or a portion of the network 1680 may include a wireless or cellular network and the coupling 1682 may be a Code Division Multiple Access (CDMA) connection, a Global System for Mobile communications (GSM) connection, or another type of cellular or wireless coupling. In this example, the coupling 1682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 4G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1616 may be transmitted or received over the network 1680 using a transmission medium via a network interface device (e.g., a network interface component included in the communication components 1664) and utilizing any one of a number of well-known transfer protocols (e.g., HTTP). Similarly, the instructions 1616 may be transmitted or received using a transmission medium via the coupling 1672 (e.g., a peer-to-peer coupling) to the devices 1670. The term “transmission medium” shall be taken to include any intangible medium that is capable of storing, encoding, or carrying the instructions 1616 for execution by the machine 1600, and includes digital or analog communications signals or other intangible media to facilitate communication of such software.

Appendix A includes example JSON (JavaScript Object Notation) code for some example natural language patterns, which can be used in conjunction with some implementations of the technology described herein. All or a portion of the code shown in Appendix A identifies various patterns. These patterns may correspond to the natural language patterns 135 stored in the data repository 130. The server 120 may use these patterns to process text (e.g., from the client device 120 or from another server or data repository, such as a machine associated with a social networking service). The patterns of Appendix A may be used to associate the text with various word groups. The word groups may be used to detect grammatical errors in the text or to identify the text as including inappropriate (e.g., pornographical or hate speech) content. The identification of inappropriate content may be fine-tuned, for example, to allow personal identification statements (e.g., “I am a Catholic gay.”) while disallowing statements that disparage certain groups.

What is claimed is:

1. A system comprising:
processing hardware; and
a memory storing instructions which, when executed by the processing hardware, cause the processing hardware to perform operations comprising:
accessing, via an electronic transmission, a text in a natural language;
identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language; and
providing an output representing the identified one or more word groups and the at least one stored natural language pattern corresponding to each of the identified one or more word groups.

2. The system of claim 1, the operations further comprising:
receiving, as input, a representation of a new pattern for addition to the plurality of stored natural language patterns residing in the data repository, wherein the new pattern is defined using one or more of the plurality of stored natural language patterns.

3. The system of claim 1, wherein a specific stored natural language pattern is represented, within the data repository, as a plaintext file that includes a list of words or a reference to another stored natural language pattern.

4. The system of claim 1, wherein a specific stored natural language pattern from the plurality of stored natural language patterns identifies one or more words that are excluded, and one or more words or one or more sub-patterns that are required, wherein the identified one or more words that are excluded are not present in a word group corresponding to the specific stored natural language pattern, and wherein the identified one or more words or one or more sub-patterns that are required are present in the word group corresponding to the specific stored natural language pattern.

5. The system of claim 1, wherein a specific stored natural language pattern from the plurality of stored natural language patterns identifies one or more other stored natural language patterns that are excluded, and wherein the identified one or more other stored natural language patterns are not present in a word group corresponding to the specific stored natural language pattern.

6. The system of claim 5, wherein the specific stored natural language pattern identifies at least one exclusion exception pattern, wherein the at least one exclusion exception pattern corresponds to the one or more other stored natural language patterns that are excluded, but wherein the at least one exclusion exception pattern is present in the word group corresponding to the specific stored natural language pattern.

7. The system of claim 1, wherein a specific stored natural language pattern from the plurality of stored natural language patterns identifies one or more other stored natural language patterns that are required, and wherein the identified one or more other stored natural language patterns are present in a word group corresponding to the specific stored natural language pattern.

8. The system of claim 1, wherein a specific stored natural language pattern identifies an order of two or more other stored natural language patterns within the specific stored natural language pattern within word groups corresponding to the specific stored natural language pattern.

9. The system of claim 1, wherein a specific stored natural language pattern identifies two or more other stored natural language patterns within the specific stored natural language pattern without specifying an order for the two or more other stored natural language patterns within word groups corresponding to the specific stored natural language pattern.

10. The system of claim 1, wherein the word-phrase type comprises a numerical text.

11. The system of claim 1, wherein the natural language comprises a spoken or written language used by humans for communication.

12. The system of claim 1, the operations further comprising:
determining, based on the identified one or more word groups and the at least one stored natural language pattern, that the text includes a grammatical error; and
providing an output representing the grammatical error.

13. The system of claim 1, the operations further comprising:
determining, based on the identified one or more word groups and the at least one stored natural language pattern, that the text includes inappropriate content; and
providing an output representing the inappropriate content.

14. A non-transitory machine-readable medium storing instructions which, when executed by one or more machines, cause the one or more machines to perform operations comprising:
accessing, via an electronic transmission, a text in a natural language;
identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language; and
providing an output representing the identified one or more word groups and the at least one stored natural language pattern corresponding to each of the identified one or more word groups.

15. The machine-readable medium of claim 14, the operations further comprising:
receiving, as input, a representation of a new pattern for addition to the plurality of stored natural language patterns residing in the data repository, wherein the new pattern is defined using one or more of the plurality of stored natural language patterns.

16. The machine-readable medium of claim 14, wherein a specific stored natural language pattern is represented, within the data repository, as a plaintext file that includes a list of words or a reference to another stored natural language pattern.

17. The machine-readable medium of claim 14, wherein a specific stored natural language pattern from the plurality of stored natural language patterns identifies one or more words that are excluded, and one or more words or one or more sub-patterns that are required, wherein the identified one or more words that are excluded are not present in a word group corresponding to the specific stored natural language pattern, and wherein the identified one or more words or one or more sub-patterns that are required are present in the word group corresponding to the specific stored natural language pattern.

18. The machine-readable medium of claim 14, wherein a specific stored natural language pattern from the plurality of stored natural language patterns identifies one or more other stored natural language patterns that are excluded, and wherein the identified one or more other stored natural language patterns are not present in a word group corresponding to the specific stored natural language pattern.

19. The machine-readable medium of claim 18, wherein the specific stored natural language pattern identifies at least one exclusion exception pattern, wherein the at least one exclusion exception pattern corresponds to the one or more other stored natural language patterns that are excluded, but wherein the at least one exclusion exception pattern is present in the word group corresponding to the specific stored natural language pattern.

20. A method comprising:
accessing, via an electronic transmission, a text in a natural language;
identifying, based on a plurality of stored natural language patterns residing in a data repository, one or more word groups within the text, each word group corresponding to at least one stored natural language pattern, each stored natural language pattern corresponding to a grammatical part of speech or a word-phrase type in the natural language; and
providing an output representing the identified one or more word groups and the at least one stored natural language pattern corresponding to each of the identified one or more word groups.
